(19) United States
(12) Patent Application Publication
(10) Pub. No.: US 2003/0129315 A1
(43) Pub. Date: Jul. 10, 2003

(54) Binders for coatings

(76) Inventors: Navin Suyal, Edinburgh (GB); Habib Ur Rehman, Edinburgh (GB)

Correspondence Address: Thomas N Young, Young & Basile, Suite 624, 3001 West Big Beaver Road, Troy, MI, 48084, US

(21) Appl. No.: 10/276,809

(22) PCT Filed: May 18, 2001
(86) PCT No.: PCT/GB01/02204

(30) Foreign Application Priority Data
May 18, 2000 (GB) 00119644

(51) Int. Cl. B05D 3/02

(52) U.S. Cl. 427/397.7

(57) ABSTRACT

The present invention relates to a method of producing a silica glass coating comprising the steps of: a) producing a sol comprising colloidal silica and an organic binder; b) forming a coating of said sol on a substrate; c) drying the sol coating so as to produce a gel coating on said substrate; and d) densifying the gel coating so as to produce a substantially crack-free glass coating. In accordance with the present invention there is used a cellulose based binder which enables the use of substantially reduced levels. of binder.

The present invention relates to the preparation of high quality glass coatings.

Various optical and electro-optical components require the production of high quality glass coatings on various substrates. The production of such coatings presents particular problems due to the difficulties involved in producing a strongly attached coating whilst avoiding cracking of the coating due to one case or another. It is known to include an organic binder in the colloidal silica sols used to produce the coatings. It is, however, necessary to employ relatively high concentrations of the binder, which has the disadvantage of reducing the optical quality of the coating.

In more detail, optical quality glass films with thickness in the range of 1-15 μm and controlled and variable refractive indices containing low hydroxyl content and impurities find many applications in optics and optoelectronics' and for decorative and protective applications. The existing production methods like flame hydrolysis or chemical vapour depositions [1] are very time- and cost-intensive. Further, these known methods rely on the thermal decomposition of metal halides, which also produces gases like Cl₂ and HCl. Therefore, stringent environmental and explosion protection measures are required. Sol-gel processing is a low cost, low temperature method for the production of glass coatings [2-5], but it has not been possible to produce films with thickness >1 micron using sol-gel processing because of the cracking of films during drying and densification [6]. Therefore, a cost effective environmentally safe route for the synthesis of optical quality glass films with variable refractive indices is needed.

Multi-cycle sol-gel production processes for glass coatings have been attempted to obtain coatings with thickness >1 μm [7,8] (by applying as many as 40 layers to obtain 8-10 microns) but that makes the process slow and expansive and there is also a problem of contamination after each step. Different approaches have been attempted by Brinker and Reed [9], Hoshino et al. [10], Innocenzi et al. [11] and Mennig et al. [12] which address the problem of insufficient thickness only partly or the densification temperature is >1200° C. which is too high for coatings on silicon or fused silica substrates. Further there also are problems like presence of organic groups in the densified film and inadequate film quality for optical applications [11,12]. Yamane and co-workers [13] have used interfacial polymerisation for the synthesis of thick SiO₂ films (2-20 μm) but there are problem with the densification and cracking. Costa, et al. [14] invented a sol-gel method for the synthesis of SiO₂ coatings up to 20 μm thick using fumed silica (Aerosil OX-50) powders dispersed in a Si(OC₂H₅)₄ derived sol. These coatings had to be densified at temperatures up to 1400° C., which is too high for SiO₂ or Si substrates. The use of organic binders for the synthesis of bulk ceramics or ceramic coatings is known [15, 16, 17, 18, 19], though the thickness of the coatings achieved has been <2 micron and these coatings are not suitable for optical applications.

It is an object of the present invention to avoid one or more of the above disadvantages. It is a further object of the present invention to provide an economic and environmentally safe method for the synthesis of optical quality glass coatings in the thickness range from 1 to 15 microns.

It has now been found that high quality glass coatings which are substantially crack-free can be produced in a particularly simple and economic manner using a so-called sol-gel process with a cellulose based binder.

The present invention provides a glass coating produced by means of a sol-gel process using an organic binder, characterised in that said organic binder is a cellulose-based binder.

In another aspect the present invention provides a method of producing a silica glass coating comprising the steps of:

a) producing a sol comprising colloidal silica and an organic binder;

b) forming a coating of said sol;

c) drying the sol coating so as to produce a gel coating; and

d) densifying the gel coating so as to produce a substantially crack-free glass coating,

where is used a cellulose based binder.

The new binders provided by the present invention play a relatively passive role in the sol so that various compounds capable of modifying optical, thermal, mechanical or rheological properties of the resulting glass coatings can be added without the occurrence of any agglomeration or premature gelation in the sol whereby economic production of glass coatings with a wide range of refractive indices across the range required for optical applications, is possible. Further, these additives result in a very environmentally safe process with no health hazards.

The coatings produced by the method of the present invention are suitable for the fabrication of opto-electronic components like planar waveguides, splitters, couplers, Bragg gratings, arrayed waveguide gratings, Mach Zehnder filters, etc. Additionally, such coatings can also be used for sensors, for decorative and protective applications and as hard anti-reflective coatings.

In addition, with preferred forms of the invention there may be used heating rates as high as 250° C./min, which reduces total heat treatment time and makes multi-layer coatings containing 2 to 5 layers also economic.

Various kinds of cellulose based binders are readily available, such binders being used for diverse purposes such as paper and pharmaceutical industries, albeit they have never previously been used in glass films or coatings. The binders of the present invention are generally one or more of a cellulose and/or a derivative thereof which can be dissolved in water, alcohols or other, organic solvents. Preferred derivatives are generally those containing hydrophilic groups such as hydroxy, carboxy, ester and amino. Particularly suitable cellulose binders which may be mentioned are butyl cellulose, ethyl cellulose, ethoxylated ethyl cellulose, benzyl cellulose, hydroxybutyl methyl cellulose, hydroxyethyl cellulose, hydroxyethyl cellulose methacrylate, hydroxypropyl cellulose, hydroxypropyl methyl cellulose, methyl cellulose, methyl cellulose acrylate, cellulose acetate phthalate (CAP) and cellulose acetate trimellitate (CAT), carboxymethyl cellulose ether, cellulose N,N-diethylaminoethyl ether, cellulose acetate, cellulose acetate butyrate, cellulose acetate phthalate, cellulose acetate propionate, cellulose acetate trimellitate, cellulose acrylamide adduct, cellulose ester, cellulose ethers, cellulose ethyl 2-hydroxyethyl ether, cellulose ethyl methyl ether, cellulose nitrate, cellulose propionate, cellulose triacetate, sodium carboxymethyl cellulose, sodium carboxymethyl hydroxyethyl cellulose, natural tree based water/alcohol soluble celluloses. Most preferred cellulose based binders are methyl cellulose, hydroxybutyl methyl cellulose, and hydroxyethyl methyl cellulose, hydroxypropyl methyl cellulose.

It has been found that much lower amounts of cellulose based binder are necessary to form a continuous crack free dried coating as compared to, conventionally used binders such as PVA binders. Surprisingly the addition of only as little as less than 20 wt % methyl cellulose results in crack free gel films after drying as against a minimum of 32 wt. % needed for PVA type binders. Lower amounts of binder has the advantage of lower residual carbon levels in the final glass coating and therefore ensures higher optical quality. The molecular weight of the binders lies between 12,000 to 200,000, the preferred molecular weight being 15,000 to 90,000.

The cellulose based binders can be added directly to the colloidal silica sol or alternatively can first be dissolved in one or more solvents used in conventional sol-gel processing such as water, ethanol, methanol, propanol, isopropanol, butanol, ethoxyethanol, benzene, acetone, phenol, and the resulting binder solution then added to the sol and mixed together therewith.

Colloidal silica (Sio₂) sols with a wide range of particle sizes, particle size distributions and wide choice of dispersion or suspension media are commercially available from a number of sources. The preferred examples of such products are Bayer-Kieselsol (types VP-AC 4038, VP-AC 4039, 200/30%, 300/30% and 300 F/30%), Catalysts and Chemicals Ind. Co. Ltd. (type Cataloid SN), Nissan (types MA-ST, IPA-ST). Further, such sols with controlled particles sizes can also be synthesised using Stoeber process [20], which entails hydrolysis and polycondensation of metal alkoxides under basic conditions in the presence of a suitable solvent such as ethanol at slightly elevated temperatures. The solid content of the sol can be adjusted between 15 to 35 wt. % using rotary evaporation. Rotary evaporation also allows obtaining suspensions in other media such as alcohols or other organic solvents.

Advantageously the silica particles may also contain 0 to 25 mole % Sio₂ moieties containing aliphatic or aromatic organic groups homogeneously embedded in the SiO₂ matrix. Further details of the use of such “organically-doped” silica particles are included in our co-pending application of even date. In general such “organically-doped” silica particles can be derived from a first, non-hydrolytically removable group containing, precursor of the formula Rₓ—SiA₄₋ₓ wherein, R represents at least one organic moiety which is hydrolytically non-removable from the Si and which has a decomposition temperature at which the R moiety decomposes, A represents at least one hydrolysable moiety, and x=1,2 or 3 and wherein when two or more A and/or R moieties are present, they may be the same or different from one another, provided that when at least some of said colloidal silica is derived from a said non-hydrolytically removable group-containing precursor, then at least 50 mole % of said colloidal silicon is derived from a second precursor of the formula SiA₄ wherein A has the same meaning as before, said colloidal silica having been derived from said first and second precursors in intimate admixture with each other.

Where such a first precursor has been used, then it is important that the amount of R group material should be limited in order to minimise the content of organic material in the final glass coating as this can have a deleterious effect on the quality thereof e.g. the inclusion of carbon particles or other decomposition products from the R group material within the final glass coating. Accordingly it is also important that any such R group material should be more or less evenly distributed within the individual colloidal silica particles, and amongst them, so as to reduce for example the possibility of having pockets of relatively high concentrations of the R group material within and amongst the colloidal silica particles. In such cases therefore the colloidal silica particles should be produced by simultaneous hydrolysis of the first precursor in the presence of a sufficient amount of the second precursor so that any R groups are well distributed and limited in concentration within the silica polymer networks which form the colloidal silica particles.

Where it is desired to use an “R-doped” colloidal silica sol in the method of the present invention then this is preferably obtained from a mixture of from 3 to 12 mole % of said first precursor with 97 to 88 mole % of a second said precursor, for example about 8 mole % of a said first precursor with 92 mole % of a said second precursor.

Particularly suitable examples of the first precursor that may be mentioned are methyltriethoxysilane, ethyl-triethoxysilane, ethyl-trimethoxysilane, benzyl-triethoxysilane and benzyl-trimethoxysilane and of the second precursor are tetraethoxysilane (TEOS) and tetramethoxysilane (TMOS).

The suspension medium of the sol can be any one used in conventional sol-gel processing such as C1 to C6, preferably C1 to C4, alkanol or other convenient organic solvent. The pH of the sols can also be adjusted suitably in the acidic or basic region in generally known manner, the SiO₂ content of the sol is preferably adjusted to between 15 to 35% (by weight) if required, by any convenient method, e.g. rotary evaporation to remove excess solvent.

If desired one or more other oxide compounds, such as B₂O₃, P₂O₅, TiO₂, Al₂O₃, GeO₂, Er₂O₃, Nd₂O₃, or Tm₂O₃ may also be added during the production of these colloidal sols. Common salts, metal alkoxides and organo-metallic compounds can also be used as the source of these oxides. Preferably the incorporation of such other oxide compounds is in the range of from 0 to 30 mole % with respect to the solid SiO₂ content (organically doped or otherwise).

It is also possible to use a colloidal silica sol wholly or partly consisting of a commercial sol. The suspension medium can be water and/or an organic solvent as mentioned above, suitable examples including ethanol, methanol, propanol, isopropanol, butanol, ethoxyethanol, benzene, acetone, phenol etc.

Various other additives can also be included if desired in generally known manner for compositional, Theological or other reasons, including one or more of the following:

(a) Suspensions of one or more of TiO₂ (0-12 mole %), ZrO₂ (0-8 mole %) and Al₂O₃ (0-8 mole %) (all %ages are with reference to solid SiO₂ including organically doped SiO₂) with particle sizes in the range from 3 to 30 nm. These Al₂O₃, TiO₂ and ZrO₂ suspensions can be self synthesised using controlled hydrolysis of aluminium secbutoxide, isobutyl aluminoxytriethoxysilane, titanium isopropoxide and zirconium propoxide respectively [6], or they can be procured commercially.

(b) 0 to 20 mole % (with reference to solid Sio₂— including organically doped SiO₂) of one or more of colloidal powders of SiO₂, TiO₂, Al₂O₃ and ZrO₂ with particle diameter in the range 5 to 40 nm and can be dispersed mechanically or ultrasonically.

(c) 0 to 25 mole % (with reference to solid SiO₂) of one or more of common salts (such as nitrates, oxalates, carbonates, acetates, chlorides, sulphates), metal alkoxides, organometallic or organic compounds of elements such as Ge, Al, Ti, Zr, Pb, Na, B, P, Sn, La, Er, Nd, Pr, Tm, Eu and Yb (Or their solutions in suitable solvents like waters alcoholic or aromatic solvents). The examples of preferred compounds are, Ti-butoxide, Ti-isopropoxide, Ti-bis (triethanolamine) diisoproxide (80% in 2propanol), Ti-diisopropoxide bis-2,4-pentanedionate in 75% isopropanol, titanium trichoride, Al-propoxide, aluminium acetylacetonate, aluminium sec-butoxide, aluminium nitrate nonahydrate, triethyl-phosphate, phosphoric acid, trimethyl phosphate, ammonium dihydrogen phosphate, triphenylphosphate, tetrabutylammonium hexafluorophosphate, triethylphosphate, zirconium n-butoxide, zirconium 2,4-pentanedionate, zirconium n-propoxide, zirconium di-n-butoxide(bis-2,4-pentanedionate), boric acid, boron methoxide, triethanolamineborate, triisopropyl borate, triethyl borate, tri-n-butyl borate or triethylgermanium, tetra-n-butylgermanium, germanium n-butoxide, germanium isopropoxide, triethylgermanium chloride, lead acetate, lead nitrate, lead(II) hexafluoroacetylacetonate, lead trifluoroacetate, lead(II) citrate trihydrate, lead(II) acetate trihydrate, erbium nitrate, erbium-2,4-pentanedionate hydrate, erbium methoxyethoxide, erbium trichloride and niobium ethoxide, tellurium ethoxide, ceriumneodymium nitrate, thulium nitrate, thulium alkoxides.

From 0 to 2% w/w (with reference to total solid oxides) of other additives such as surfactants or dispersing agents can also be added if desired. The pH of the sol can also be adjusted at any of the above stages using suitable acids or bases used in conventional sol-gel processing.

The cellulose-based binder containing sols may be coated on to glass, ceramic or crystalline substrates that are high temperature resistant (at least 500° C.) using any suitable technique known in the sol-gel processing art such as spin, spray, dip and flow coating or by doctor blade methods at any convenient temperature generally from 0 to 100° C. under air, or any other convenient atmosphere, such as one containing one or more of oxygen, ammonia, nitrogen or argon. Suitable glass substrates include SiO₂ or high silica based glasses, silicon oxynitride and oxycarbide glasses. Suitable ceramic substrates include Si₃N₄, SiC, Alumina and phases thereof such as Corundum. Suitable crystalline substrates include crystalline Si and diamond. The substrates used may have different thermal history and they may contain oxide or other layers grown thermally or formed thereon by any other suitable method.

If desired a layer of adhesion promoters (such as AP2500, AP3000 or AP8000, from Dow chemical company) can first be applied on to the substrate surface before the application of the sol coatings thereonto.

The sol coating thus produced is then dried in generally known manner so as to produce a gel coating. In general drying is carried out at a temperature of from 10 to 200° C. When an elevated temperature is used, the coating is generally heated at a rate of from 2 to 100° C./min. Drying may be carried out in air, or if desired, under an atmosphere comprising one or more of an inert gas (such as N₂, He, Ar), and/or oxygen.

The gel coatings may optimally be subjected to an additional heat treatment if desired, at temperatures up to 750° C., under air or other common gases such oxygen, hydrogen, nitrogen, ammonia or a mixture thereof with heating rates of from 100 to 250° C./min. A soaking period at the final temperature can be up to 5 hrs. If desired also vapours of one or more of the compounds such as GeCl₄, POCl₃, AlCl₃, BCl₃, SiF₄, TiCl₄, SnCl₄, BBr₃, PCl₃, ErCl₃, NdCl₃ or a solution thereof in a suitable solvents, with or without a carrier gas, can also be passed over the coatings.

At this stage one obtains, as a result of the removal of the binder by the heat treatment (with partial densification of the gel coating), porous gel coatings with different degrees of porosity and pore sizes depending upon the particular process conditions and thermal history. These gel coatings may also be used as such for any further processing such as impregnation with optically, chemically or structurally active components. Alternatively one may proceed directly with densification treatment by further increasing the temperature to a suitable value in accordance with conventional practice in the sol-gel processing art, generally up to a temperature from 900 to 1300° C., preferably from 950 to 1200° C. Normally the coating is soaked at the final densification temperature for some time, conveniently minutes to 10 h, to obtain a dense glass coating. Atmosphere of air, oxygen, nitrogen, ammonia, CCl₂F₂, CF₄, SF₆, SiF₄ or a mixture thereof can be chosen during heat treatment. P The densification treatment may conveniently be carried out in a rapid thermal annealer at temperatures up to 1300° C. under an atmosphere as described immediately hereinbefore. The gel coatings may also be densified by exposing them to a gas plasma for a suitable period e.g. from 2 min to 5 h. Typically the gas pressure used in the plasma is around 5 Pa. Various other densification treatments known in the sol-gel art could also be used if desired including one or more of radio frequency, microwave (secondary microwave heating), thermal, flame, radiation and combinations thereof under an atmosphere comprising a nitrogen, fluorine or phosphorous containing gas.

At the end of this process, high quality crack-free glass coatings with a wide range of refractive indices with a thickness of up to 10 μm or more, can be obtained. Such refractive index controlled optical quality glass coatings are suitable for optical, opto-electronic and sensor applications and in protective or decorative applications.

The glass coatings obtained by the method of the invention, may be subjected to further processing, in the normal way. Typically where they are used for the core layer in an optoelectronic component, they may be structured with the help of photo-lithography using appropriate masks followed by wet or dry etching etc. as required to obtain components such as planar waveguides, splitters, couplers, arrayed waveguide gratings and Mach Zehnder filters.

The glass coatings may also have applied thereto further coatings, conveniently by the method of. the present invention, to increase the thickness of the first layer, and/or to provide on the top surface thereof, a cladding layer with a refractive index lower by an amount ranging from 0.25 to 10% (as compared to the core layer).

The invention is further illustrated by the following examples, which are illustrative of various preferred aspects of practising the invention and should not be taken as limiting the scope of the invention to be defined by the claims.

### EXAMPLE 1

### Preparation of Colloidal Silica Sol

Tetraethoxysilane (63 g) was mixed with ethanol (170 g) and deionised water (102 g) while stirring. Finally ammonia (0.30 g 35% aqueous solution) was added and stirred for several minutes. This mixture was heated up to 80° C. under reflux and stirred for 96 h. The SiO₂ content of the sol was adjusted to 30% (by weight) using rotary evaporation.

### EXAMPLE 2

### Preparation of Glass Coating

50 g of the sol (30 wt. % in water) obtained in Example 1 was mixed with 75 g Methyl Cellulose solution (MW 63000, 4 wt. % in water, from Sigma-Aldrich). To this mixture was added 6.5 g Poly(ethylene glycol) solution (MW 2000, 15 wt. % in water) and resulting solution was stirred at ambient temperature for 24 h. pH of the sol was adjusted between 9.5 to 10 by the drop wise addition of 0.25 g of 25 wt % aqueous NH3. This suspension was filtered using 1 μm filter and applied on to a Si crystal wafer using a spin coater. The spin coating programme used was as given below:

Step 1: 10 sec at 350 rpm

Step 2: 10 sec at 500 rpm

Step 3: 20 sec at 750 rpm

The resulting coating was dried at ambient temperature and the dried substrate was placed in a furnace and the temperature was raised to 830° C. in 15 min under air atmosphere. After holding for 1 h at 830° C. temperature was increased to 1100° C. at a heating rate of 25° C./min and was held at this temperature for 1 h. The furnace was then switched off and allowed to cool down to 100° C. naturally. A 7 μm thick glass coating having a refractive index of 1.459 was obtained.

### EXAMPLE 3

### Preparation of Glass Coating

A Titanium sol was prepared by hydrolysing 1 mol titanium bis (triethanolamine) diisoproxide (80% in 2-propanol) in 15 mol of ethanol using 12 mol of water. Stirring was carried out at ambient temperature for 72 h and then at 50° C. for 24 h to ensure complete reaction.

50 g of the sol (30 wt. % in water) obtained in Example 1 was mixed with 82.5 g Methyl Cellulose binder solution (MW 63,000, 4 wt. % in water). To this mixture was added 11 g of titanium sol. 6.5 g Poly(ethylene glycol) solution (MW 2000, 15 wt. % in water) was also added and resulting solution was stirred at ambient temperature for 24 h. pH of the sol was adjusted between 9.5-10 by the drop wise addition of 0.25 g of 25 wt % NH₃. This suspension was filtered using 1 μm filter and applied on a Si crystal wafer using a spin coater. The spin coating programme used was as given below:

Step 1: 10 sec at 350 rpm

Step 2: 10 sec at 500 rpm

Step 3: 15 sec at 700 rpm

The resulting coating was dried at ambient temperature before densification. The dried coated substrate was placed in a furnace and temperature was raised to 830° C. in 15 min under air atmosphere. After holding for 1 h at 830° C. temperature was increased to 1100° C. at a heating rate of ²5° C./min and was held at this temperature for 1 h. Furnace was then switched off and allowed to cool down to 100° C. naturally. 5 μm thick coating having refractive index of 1.475 was obtained.

### EXAMPLE 4

### Preparation of Glass Coating

Aluminium sol was prepared by hydrolysing 1 mol Aluminium acetylacetonate in 10 mol of ethanol using 12 mol of water. Stirring was carried out at ambient temperature for 48 h and then at 50° C. for additional 24 h to ensure complete reaction. 50 g of the sol (30 wt. % in water) obtained in Example 1 was mixed with 82.5 g Methyl Cellulose solution (MW 63000, 4 wt. % in water). To this mixture was added 12 g of alumina sol. 6.5 g Poly(ethylene glycol) solution (MW 2000, 15 wt. % in water) was also added and resulting solution was stirred at ambient temperature for 24 h. pH of the sol was adjusted 9.5-10 by the drop wise addition of 0.25 g of 25 wt. % NH₃. This suspension was filtered using 1 μm filter and applied on to a four inch Si crystal wafer using a spin coater. The spin coating programme used was as given below:

Step 1: 10 sec at 350 rpm

Step 2: 10 sec at 500 rpm

Step 3: 15 sec at 700 rpm

Resulting coating was dried at ambient temperature before sintering (densification). This dried coated substrate was placed in a furnace and temperature was raised to 830° C. in 15 min under air atmosphere. After holding for 1 h at 830° C. temperature was increased to 1100° C. at a heating rate of 25° C./min and was held at this temperature for 1 h. Furnace was then switched off and allowed to cool down to 100° C. naturally. A 5 μm thick glass coating was obtained.

### EXAMPLE 5

### Preparation of Glass Coating

50 g of the sol (30 wt. % in water) obtained in Example 1 was mixed with 82.5 g Methyl Cellulose solution (MW 63,000, 4 wt. % in water). To this mixture was added 7 g of titania sol and 6 g of Alumina sol synthesised as above. 6.5 g Poly(ethylene glycol) solution (MW 2000, 15 wt. % in water) was also added and resulting solution was stirred at ambient temperature for 24 h. pH of the sol was adjusted 9.5 to 10 by the drop wise addition of 0.25 g of 25 wt. % NH₃. This suspension was filtered using 1 μm filter and applied on to a four inch Si crystal wafer using a spin coater. The spin coating programme used was as given below:

Step 1: 10 sec at 350 rpm

Step 2: 10 sec at 500 rpm

Step 3: 15 sec at 700 rpm

The resulting coating was dried at ambient temperature before densification. This dried coated substrate was placed in a furnace and temperature was raised to 830° C. in 15 min under air atmosphere. After holding for 1 h at 830° C. temperature was increased to 1100° C. at a heating rate of 0.25° C./min and was held at this temperature for 1 h. Furnace was then switched off and allowed to cool down to 100° C. naturally. A 5 μm thick glass coating having refractive index of 1.471 was obtained.

### EXAMPLE 6

### Preparation of Glass Coating

50 g of the sol (30 wt. % in water) obtained in Example 1 was mixed with 0.75 g of boric acid. To this solution was added 82.5 g Methyl Cellulose solution (MW 63000, 4 wt. % in water). Then 24 g of titania sol was added and stirring was done for two h. 6.5 g Poly(ethylene glycol) solution (MW 2000, 15 wt. % in water) was also added and resulting solution was stirred at ambient temperature for 24 h. pH of the sol was adjusted 9.5-10 by the drop wise addition of 0.25 g of 25 wt. % NH₃. This suspension was filtered using 1 μm filter and applied on a four inch Si crystal wafer using a spin coater. The spin coating programme used was as given below:

Step 1: 10 sec at 350 rpm

Step 2: 10 sec at 500 rpm

Step 3: 15 sec at 750 rpm

The resulting coating was dried at ambient temperature before sintering. This dried coated substrate was placed in a furnace and temperature was raised to 830° C. in 15 min under air. After holding for 1 h at 830° C. temperature was increased to 1100° C. at a heating rate of 25° C./min and was held at this temperature for 1 h. Furnace was then switched off and allowed to cool down to 100° C. naturally. A 4.5 μm thick glass coating having refractive index of 1.46 was obtained.

### EXAMPLE 7

### Preparation of Glass Coating

50 g of a commercial silica sol-Bayer Levasil VP-AC (30 wt. % in water) was mixed with 0.75 g of boric acid. To this solution was added 82.5 g Methyl Cellulose, binder solution (MW 63000, 4 wt. % in water). Then 6.25 g of erbium nitrate pentahydrate was added and stirring was effected for two h. 6.5 g Poly(ethylene glycol) solution (MW 2000, 15 wt. % in water) was also added and resulting solution was stirred at RT for 24 h. pH of the sol was adjusted 9.5-10 by the drop wise addition of 0.25 g of 25 wt. % NH₃. This suspension was filtered using 1 μm filter and applied on a four inch Si crystal wafer using a spin coater. The spin coating programme used was as given below:

Step 1: 10 sec at 350 rpm

Step 2: 10 sec at 500 rpm

5 Step 3: 15 sec at 750 rpm

The resulting coating was dried at ambient temperature before sintering. This dried coated substrate was placed in a furnace and temperature was raised to 830° C. in 15 min under air. After holding for 1 h at 830° C., the temperature was increased to 1100° C. at a heating rate of 25° C./min and was then held at this temperature for 1 h. The furnace was then switched off and allowed to cool down to 100° C. naturally. A 5 μm thick transparent glass coating was obtained.

### EXAMPLE 7

### Production of Glass Coating

50 g of the sol (10 wt. % in water-ethanol mixture) obtained in Example 1 was mixed with 0.75 g of boric acid. To this solution was added 75 g Methyl Cellulose binder solution (MW 63000, 4 wt. % in water). Then 2.25 g of lead acetate trihydrate in water was added slowly under vigorous stirring. 6.5 g Poly(ethylene glycol) solution (MW 2000, 15 wt. % in water) was also added and resulting solution was stirred at ambient temperature for 24 h. This mixture was concentrated in order to bring the total silica content down to 30 wt. % in the sol, using a rotary evaporator. The pH of the final sol was adjusted to 9.5 to 10 by the drop wise addition of 0.25 g of 25 wt. % aqueous NH₃. This suspension was filtered using a 1 μm filter and applied on to a four inch Si crystal wafer using a spin coater. The spin coating programme used was as given below:

Step 1: 10 sec at 350 rpm

Step 2: 10 sec at 500 rpm

Step 3: 15 sec at 750 rpm

The resulting coating was dried at ambient temperature before densification. This dried coated substrate was placed in a furnace and temperature was raised to 830° C. in 15 min under air atmosphere. After holding for 1 h at 830° C. temperature was increased to 1100° C. at a heating rate of 25C/min and was held at this temperature for 1 h. The furnace was then switched off and 5 allowed to cool down to 100° C. naturally. A 4.5 μm thick clear glass coating was obtained.

1 Gusev, E. P., Lu, H. C., Garfunkel, E. L., Gustafsson, T. and Green M. L., IBM J. Res. Develop., Vol. 43, No. 3 (1999) p. 265.

2 Schroeder, H., in ‘Physics of thin films’, ed. G. Haas (Academic Press, NY 1969) p 87.

3 Dislich, H., in ‘Sol-Gel Technology for Thin Films, Fibers, Preforms, Electronics and Specialty Shapes’, ed. L. C. Klein, (Noyes, Park Ridge, N.J. 1988) p. 50.

4 Sakka, Sumio, In, ‘Struct. Bonding—85, Optical and Electronic Phenomena in Sol-Gel Glasses and Modern Application’ (Springer, Berlin, 1996), p. 1-49

5 Uhlmann, D. R., Boulton, J. M., Teowee, G., and Weisenbach, L., Sol-Gel Optics, Proc SPIE—Int. Soc. Opt. Eng. 1328 (1990) 270.

6 Brinker, C. J. and Sherer, G. W., Sol-Gel Science: The Physics and Chemistry of Sol-Gel Processing (Academic Press, New York, 1990).

7 Syms, R. R. A. and Holmes, A. S., IEEE Photonics Tech. Lett., 5[9] (1993) 1077.

8 Holmes, A. S., Syms, R. R. A., Li, Ming. And Green, M., Appl. Opt. 32[25] (1993) 4916.

9 Brinker, C., and Reed, S. T., ‘Low Temperature Process for Obtaining Thin Glass Films’, U.S. Pat. No. 4,476,156.

10 Hoshino, S., Ito, M., and Kanamori, H., European Patent, EP 482659 A1 920429

11 P. Innocenzi, M. O. Abdirashid and M. Gulgulelmi, Jl Sol-Gel Sci. Tech. 3 (1994) 47.

12 M. Mennig, M., Jonschker, G. and Schmidt, H., in Sol-Gel Optics II: Proceedings of SPIE, 1758, edited by J. D. Mackenzie (SPIE Bellingham 1992), p.125.

13 M. Yamane, S. Shibata, A. Yasumori, T. Sano and S. Uchihiro, J. Sol-Gel Sci and Tech, 2, 457 (1994).

14 Cpsta, L., Costa, P. P. and Grandi, S., W014013A1 and ITNO980004A0

15 A. Onions, Manufacturing Chemist, March 1996, p 55 and April 1996, p.66.

16 D. Hotza and P. Greil, Material Sci. Eng. A202, (1995) 206.

17 zarzycki, J., Prassas, M., and Phalippou, J., J. Mat. Sci., 17 (1982) 3371.

18 Nelson, R. L., Ramsay, J. D. F., Woodhead, J. L., Cairns, J. and Crossley, J. J. A., Thin Solid Films, 31[4] (1981) 329.

19 Yi, G. and Sayer, M., Ceram. Bull., 70[7] (1991) 1173.

20 W. Stoeber, A. Fink and E. Bohn, J. Colloid Interface science., 26 (1968) 6 WO

1. A method of producing a silica glass coating comprising the steps of:
e) producing a sol comprising colloidal silica and an organic binder;
f) forming a coating of said sol on a substrate;
g) drying the sol coating so as to produce a gel coating on said substrate; and
h) densifying the gel coating so as to produce a substantially crack-free glass coating,
characterised in that there is used a cellulose based binder.

2. A method according to claim 1 wherein is used a cellulose based binder selected from a cellulose and a cellulose derivative.

3. A method according to claim 1 or claim 2 wherein said binder is water soluble or soluble in an alkanol having from 1 to 6 carbon atoms.

4. A method according to any one of claims 1 to 3 wherein is used not more than 25 wt % of said binder.

5. A method according to any one of claims 1 to 4 wherein is used a said binder having a molecular weight of from 12,000 to 200,000.

6. A method according to any one of claims 1 to 5 wherein is used a high temperature-stable substrate, which is heat resistant up to at least 700° C.

7. A method according to claim 6 wherein is used a substrate selected from a glass, ceramic and crystalline substrate.

8. A method according to claim 7 wherein is used a crystalline silicon substrate.

9. A method according to any one of claims 1 to 8 wherein is used a binder selected from butyl cellulose, ethyl cellulose, ethoxylated ethyl cellulose, benzyl cellulose, hydroxybutyl methyl cellulose, hydroxyethyl cellulose, hydroxyethyl cellulose methacrylate, hydroxypropyl cellulose, hydroxypropyl methyl cellulose, methyl cellulose, methyl cellulose acrylate, cellulose acetate phthalate (CAP) and cellulose acetate trimellitate (CAT), carboxymethyl cellulose ether, cellulose N,N-diethylaminoethyl ether, cellulose acetate, cellulose acetate butyrate, cellulose acetate phthalate, cellulose acetate propionate, cellulose acetate trimellitate, cellulose acrylamide adduct, cellulose ester, cellulose ethers, cellulose ethyl 2-hydroxyethyl ether, cellulose ethyl methyl ether, cellulose nitrate, cellulose propionate, cellulose triacetate, sodium carboxymethyl cellulose, sodium carboxymethyl hydroxyethyl cellulose, and natural tree based water/alcohol soluble celluloses.

10. A method according to any one of claims 1 to 9 wherein is used a binder selected from methyl cellulose, hydroxybutyl methyl cellulose, and hydroxyethyl methyl cellulose, hydroxypropyl methyl cellulose.

11. A method according to any one of claims 1 to 10 wherein is used from 14 to 25%w/w of said binder relative to the solid oxide content of said sol.

12. A method according to any one of claims 1 to 11 wherein the gel coating is densified by heat treatment at from 900 to 1300° C.

13. A method according to any one of claims 1 to 12 wherein is formed a coating of said sol on said substrate so as to provide a said substantially crack free glass coating on said substrate having a thickness of from 1 to 15 μm.

14. A glass coating when produced by a method according to any one of claims 1 to 13.

15. An optical or opto-electronic device which includes a glass coating according to claim 14.
